(19) United States
(12) Patent Application Publication
(10) Pub. No.: US 2026/0247425 A1
(43) Pub. Date: Aug. 20, 2026

(54) TXSPG SESSION NEGOTIATION PROCEDURE

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/537,199

(22) Filed: Feb. 11, 2026

Related U.S. Application Data
(60) Provisional application No. 63/758,758, filed on Feb. 14, 2025.

(51) Int. Cl. H04W 72/543; H04L 67/104

(52) U.S. Cl. CPC H04W 72/543; H04L 67/104

(57) ABSTRACT

Methods and systems for a TXSPG session negotiation procedure. A method includes setting a transmission opportunity (TXOP) sharing with peer-to-peer group (TXSPG) support field of a capabilities element. The method also includes receiving a request frame from a first non-AP STA of the group of P2P non-AP STAs, the request frame including a quality of service (QoS) characteristics element. The method also includes determining whether to accept a request from the first non-AP STA for a TXSPG session. The method also includes transmitting a response frame to the first non-AP STA indicating acceptance, rejection, or other response to the request frame.

### CROSS-REFERENCE TO RELATED APPLICATIONS AND CLAIM OF PRIORITY

The present application claims priority to U.S. Provisional Patent Application No. 63/758,758, filed on Feb. 14, 2025. The contents of the above-identified patent documents are incorporated herein by reference.

### TECHNICAL FIELD

The present disclosure relates generally to wireless communication systems. More specifically, the present disclosure relates to systems and methods for a transmission opportunity (TXOP) sharing with peer-to-peer group (TXSPG) session negotiation procedure.

### BACKGROUND

Numerous devices operating on the same network have become common. Many such devices may be latency-tolerant but still contend with devices running low-latency applications for the same time and frequency resources. In some cases, the access point (AP) serving as the network controller may not have sufficient control over unregulated or unmanaged traffic that contends with low-latency traffic within the infrastructure BSS. Some unmanaged traffic that interferes with latency-sensitive traffic may originate from peer-to-peer (P2P) networks. Next-generation WLAN systems therefore require mechanisms to better handle unmanaged traffic in order to prioritize low-latency traffic in the network. For example, two STAs can form a P2P link and can be members of a peer-to-peer group. However, no mechanism exists for an AP to manage P2P groups even though most P2P STAs operate within a P2P group.

### SUMMARY

The present disclosure relates generally to wireless communication systems and, more specifically, the present disclosure relates to systems and methods for a TXSPG session negotiation procedure.

In one embodiment, a method performed by an AP device is provided. The method includes setting a TXSPG support field of a capabilities element. The method also includes receiving a request frame from a first non-AP STA of the group of P2P non-AP STAs, the request frame including a quality of service (QoS) characteristics element. The method also includes determining whether to accept a request from the first non-AP STA for a TXSPG session. The method also includes transmitting a response frame to the first non-AP STA indicating acceptance, rejection, or other response to the request frame.

In another embodiment, a method performed by a first non-AP station (STA) of a group of peer-to-peer (P2P) non-AP STAs is provided. The method includes setting a TXSPG support field of a capabilities element. The method also includes transmitting a request frame to a first AP device, the request frame including a QoS characteristics element. The method also includes receiving a response frame from the first AP device indicating acceptance, rejection, or other response to the request.

In yet another embodiment, an electronic device is provided. The electronic device includes at least one processor including processing circuitry and a memory storing instructions. The instructions, when executed by the at least one processor individually or collectively, cause the electronic device to set a TXSPG support field of a capabilities element. The instructions, when executed by the at least one processor individually or collectively, also cause the electronic device to receive a request frame from a first non-AP STA of the group of P2P non-AP STAs, the request frame including a QoS characteristics element. The instructions, when executed by the at least one processor individually or collectively, also cause the electronic device to determine whether to accept a request from the first non-AP STA for a TXSPG session. The instructions, when executed by the at least one processor individually or collectively, also cause the electronic device to transmit a response frame to the first non-AP STA indicating acceptance, rejection, or other response to the request frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIGS. 3A-3C illustrate an example system supporting a TXSPG session negotiation procedure in accordance with this disclosure;

FIG. 4 illustrates an example transmission diagram of a TXSPG session negotiation procedure in accordance with this disclosure;

FIG. 5 illustrates an example transmission diagram of a TXSPG session negotiation procedure in accordance with this disclosure;

FIG. 6 illustrates an example flow chart of a method for a TXSPG session negotiation procedure according to this disclosure; and

FIG. 7 illustrates an example flow chart of a method for a TXSPG session negotiation procedure according to this disclosure.

### DETAILED DESCRIPTION

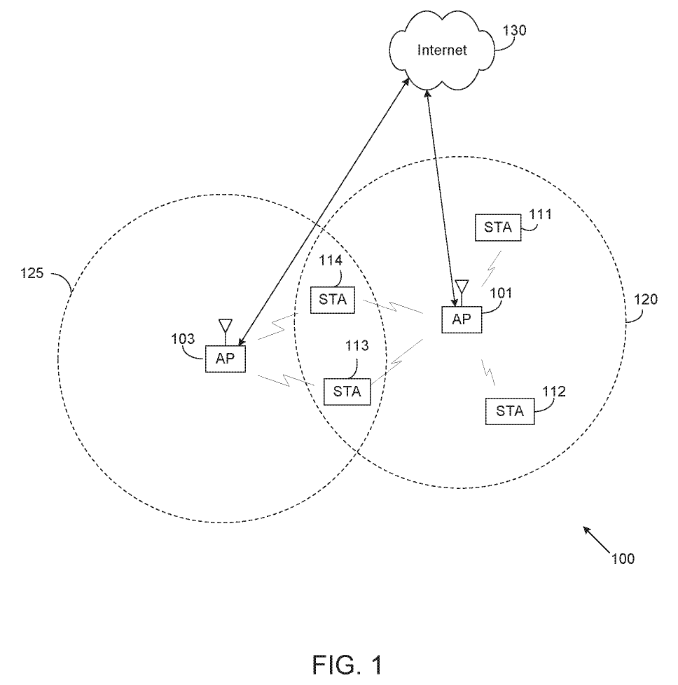

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As discussed above, a Wireless Local Area Network (WLAN) allows devices to access the internet in the 2.4 GHz, 5GHz, 6GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards, such 802.11ac, 802.11ax, and 802.11bn.

In particular, next-generation WLAN systems need to provide better support for low-latency applications. Numerous devices operating on the same network have become common. Many such devices may be latency-tolerant but still contend with devices running low-latency applications for the same time and frequency resources. In some cases, the access point (AP) serving as the network controller may not have sufficient control over unregulated or unmanaged traffic that contends with low-latency traffic within the infrastructure BSS. Some unmanaged traffic that interferes with latency-sensitive traffic in the BSS managed by the AP may originate from uplink (UL), downlink (DL), or direct link communications within the infrastructure BSS that the AP manages. Other unmanaged traffic may result from transmissions in the neighboring infrastructure BSS (OBSS), while still other sources may include neighboring independent BSS or P2P networks. Next-generation WLAN systems therefore require mechanisms to better handle unmanaged traffic in order to prioritize low-latency traffic in the network.

For example, two STAs can form a peer-to-peer (P2P) link and can be members of a peer-to-peer group. However, no mechanism exists for an AP to manage P2P groups even though most P2P STAs operate within a P2P group.

Accordingly, the present disclosure provides systems and methods for a TXSPG session negotiation procedure. As described herein, the present disclosure includes systems and methods that include setting a TXSPG support field of a capabilities element. The method also includes receiving a request frame from a first non-AP STA of the group of P2P non-AP STAs, the request frame including a QoS characteristics element. The method also includes determining whether to accept a request from the first non-AP STA for a TXSPG session. The method also includes transmitting a response frame to the first non-AP STA indicating acceptance, rejection, or other response to the request frame.

The present disclosure, thus, provides for methods and systems where an AP device is configured to allow management of a P2P group that uses a TXOP facilitated by the AP device.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for a TXSPG session negotiation procedure. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

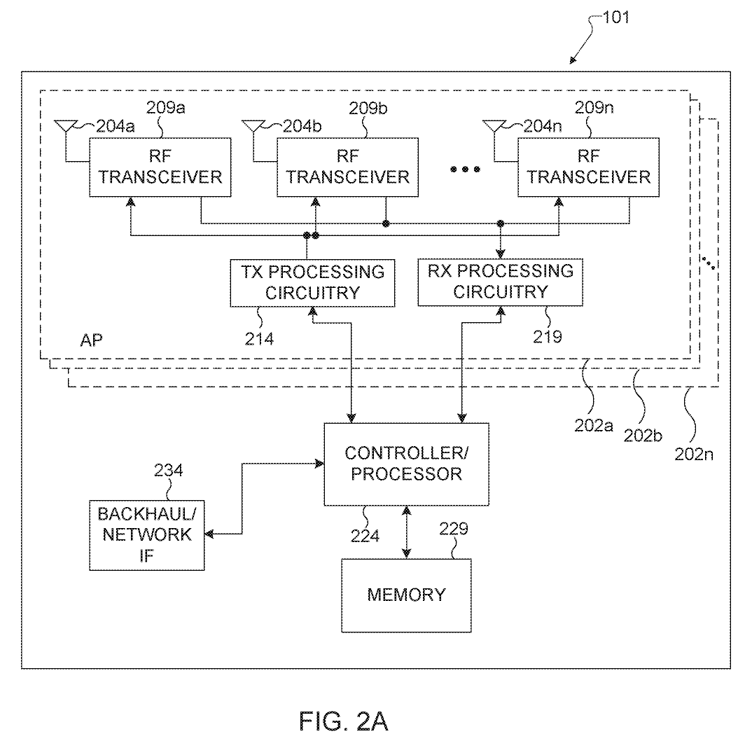

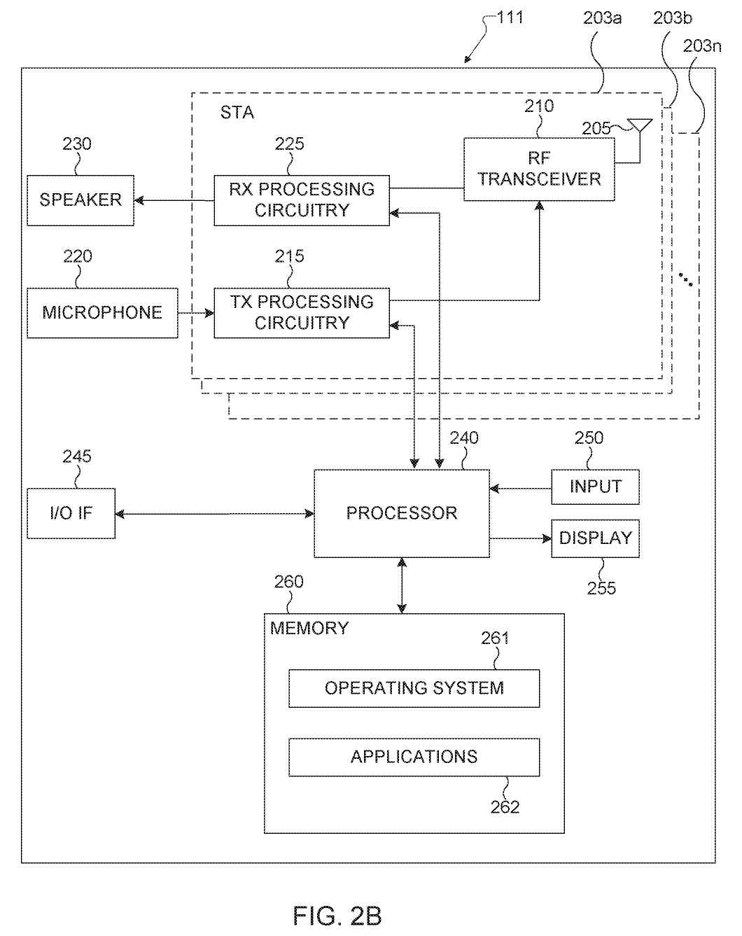

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHz, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating a TXSPG session negotiation procedure. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for a TXSPG session negotiation procedure. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring a TXSPG session negotiation procedure. In some embodiments, the controller/processor 240 includes at least one microprocessor or microcontroller.

The processor 240 is also capable of executing other processes and programs resident in the memory 260, such as operations for facilitating a TXSPG session negotiation procedure. The controller/processor 240 can move data into or out of the memory 260 as required by an executing process. In some embodiments, the controller/processor 240 is configured to execute a plurality of applications 262, such as applications for facilitating transmission for reception at an associated AP and an unassociated AP. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

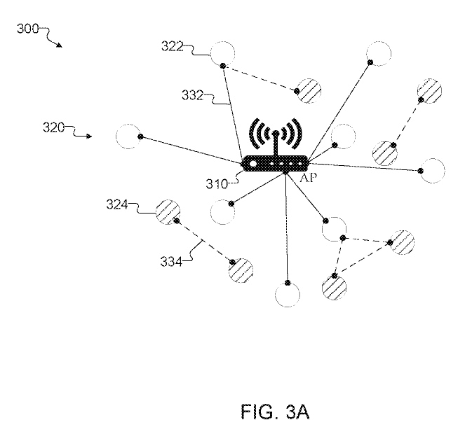

FIGS. 3A-3C illustrate an example wireless communication system 300 supporting a TXSPG session negotiation procedure in accordance with this disclosure. In particular, FIG. 3A illustrates a wireless communication system 300 where infrastructure traffic and non-infrastructure traffic coexist, FIG. 3B illustrates a TXOP sharing configuration 302A for a non-AP STA, and FIG. 3C illustrates a TXOP sharing configuration 302B for a peer-to-peer (P2P) group.

As shown in FIG. 3A, the wireless communication system 300 includes a first AP device 310 communicatively coupled to a plurality of non-AP STAs 320. The plurality of non-AP STAs 320 may include associated non-AP STAs 322 and unassociated non-AP STAs 324. For example, the associated non-AP STAs 322 may form a UL/DL link 332 with the first AP device 310 while the unassociated non-AP STAs 324 may form a direct link 334 with the associated non-AP STAs 322 or with other unassociated non-AP STAs 324.

As shown in FIG. 3B, the wireless communication system 300 may include a TXOP sharing configuration 302A for a non-AP STA. For example, the associated non-AP STAs 322 may include a first non-AP STA 342, a second non-AP STA 344, and a third non-AP STA 346. The associated non-AP STAs 322 may form infrastructure traffic link with the first AP device 310, such as a infra-traffic link 348 between the first non-AP STA 342 and the first AP device 310, the second non-AP STA 344 and the first AP device 310, and the third non-AP STA 346 and the first AP device 310. Additionally, the first AP device 310 may provide a TXOP 350 to the associated non-AP STAs 322, such as to the first non-AP STA 342. The first non-AP STA 342 may also participate in P2P traffic with, for example, the second non-AP STA 344. Such traffic may include latency sensitive traffic 352 as well as non-urgent P2P traffic 354.

As shown in FIG. 3C, the wireless communication system 300 may include a TXOP sharing configuration 302B for P2P group. For example, the associated non-AP STAs 322 may include a P2P group 360 that includes a plurality of non-AP STAs 362. The first AP device 310 provides a TXOP 350 to the P2P group 360, received and managed by a first non-AP STA, such as the first non-AP STA 342.

For example, the first AP device 310 can share one of the obtained TXOPs with one or more P2P groups. When the first AP device 310 sends a TXOP to the P2P group, a non-AP STA, such as the first non-AP STA 342, that is a member of the P2P group can use that TXOP to transmit P2P traffic to other non-AP STAs. The feature in which an AP device 310 shares a TXOP with a P2P group 360 or P2P cluster is referred to as TXOP sharing for P2P Group (TXSPG).

Although FIGS. 3A-3C illustrate an example system 300 supporting a TXSPG session negotiation procedure, various changes may be made to FIGS. 3A-3C. For example, various components in FIGS. 3A-3C may be combined, further subdivided, replicated, omitted, or rearranged and additional components may be added according to particular needs.

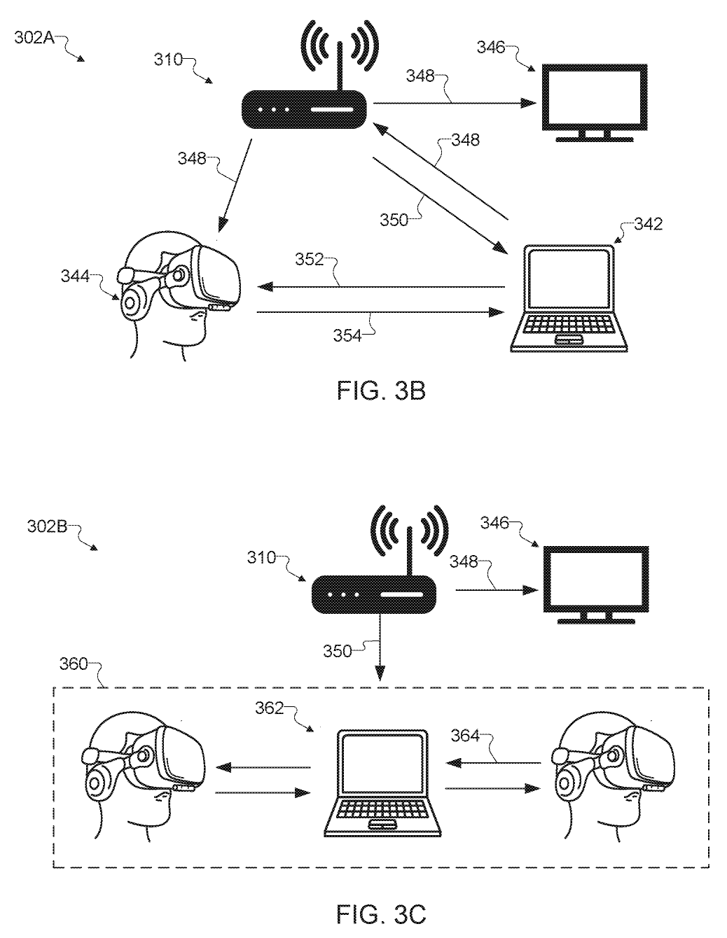

FIG. 4 illustrates an example transmission diagram 400 of a TXSPG session negotiation procedure in accordance with this disclosure. In particular, the transmission diagram 400 describes a capability exchange for TXSPG support. For ease of explanation, the transmission diagram 400 will be described as including one or more components of the wireless network 100 of FIG. 1, such as the APs 101, 103 and the STAs 111-114; however, the transmission diagram 400 could be implemented using any other suitable device or system. The embodiment of the transmission diagram 400 shown in FIG. 4 is for illustration only. Other embodiments of the transmission diagram 400 could be used without departing from the scope of this disclosure.

As shown in FIG. 4, the transmission diagram 400 includes an AP device 410 and a non-AP STA 420. At the start of a capability exchange, the non-AP STA 420 may transmit a request frame 422 to the AP device 410 requesting information regarding the capability of the AP device 410 to support TXSPG sessions. The AP device 410 may then transmit a response frame 412 in response to the request frame 422. The response frame 412 provides an indication regarding the capability of the AP device 410 to support TXSPG sessions.

For example, the AP device 410 that supports TXSPG can indicate the capability to support TXSPG in the response frame 412, such as in an element included in Beacon, Probe Response, Association Response, or Reassociation Response frames that the AP device 410 transmits. For example, the element may be a UHR Capabilities element or a UHR Extended Capability element. Additionally, in one embodiment, an AP can announce in a Beacon, Probe Response, Association Response, or Reassociation Response frame whether the AP device 410 supports TXSPG operation.

Additionally or alternatively, a non-AP STA 420 can indicate to the associated AP whether the non-AP STA 420 supports TXSPG operation in the request frame 422. The non-AP STA 420 can make such an indication in an Association Request frame, a Reassociation Request frame, a Probe Request frame, or in any other management frame or action frame.

Although FIG. 4 illustrates an example transmission diagram 400 of a TXSPG session negotiation procedure, various changes may be made to FIG. 4. For example, various components in FIG. 4 may be combined, further subdivided, replicated, omitted, or rearranged and additional components may be added according to particular needs.

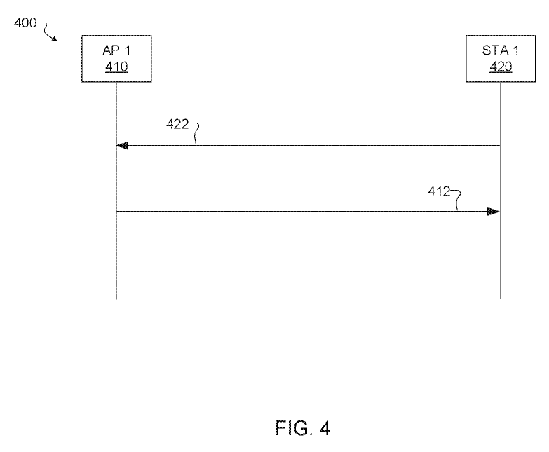

FIG. 5 illustrates an example transmission diagram 500 of a TXSPG session negotiation procedure in accordance with this disclosure. In particular, the transmission diagram 500 describes the request and response procedure to start the TXSPG session. For ease of explanation, the transmission diagram 500 will be described as including one or more components of the wireless network 100 of FIG. 1, such as the APs 101, 103 and the STAs 111-114; however, the transmission diagram 500 could be implemented using any other suitable device or system. The embodiment of the transmission diagram 500 shown in FIG. 5 is for illustration only. Other embodiments of the transmission diagram 500 could be used without departing from the scope of this disclosure.

As shown in FIG. 5, the transmission diagram 500 includes an AP device 510 and a non-AP STA 520. The first non-AP STA 520 may transmit a request frame 522 to the first AP device 510 requesting a TXSPG session. The first AP device 510 may respond using a response frame 512 that includes acceptance or denial of the TXSPG session request. If the response frame 512 includes an acceptance of the TXSPG session request, the first AP device 510 may also initiate a TXSPG session 530 with the first non-AP STA 520.

In one embodiment, a first non-AP STA 520 associated with a first AP device 510 may send a first message to the first AP device 510 requesting to start a TXSPG session 530 with the first AP device 510. The request message may be an individually addressed frame transmitted to the first AP device 510. The first non-AP STA 520 may be a member of one or more P2P groups or clusters. Alternatively, the first non-AP STA 520 may not be a member of any P2P group. In yet another embodiment, the first non-AP STA 520 may not be a member of any P2P group but may intend to start a P2P group with other STAs.

In the scenario where a first AP device 510 receives a request frame 522 from a first non-AP STA 520 to start a TXSPG session 530, upon receiving the request, the first AP device 510 may send a response frame 512 to the first non-AP STA 520 indicating whether the first AP device 510 accepts or rejects the request. When the first AP device 510 sends a response frame 512 to the first non-AP STA 520 indicating that the first AP device 510 has accepted the request, upon transmission of the response frame 512, a TXSPG session 530 is started between the first AP device 510 and the first non-AP STA 520. When the first AP device 510 sends a response frame 512 to the first non-AP STA 520 indicating that the first AP device 510 has rejected the request, upon transmission of the response frame 512, no TXSPG session 530 is started between the first AP device 510 and the first non-AP STA 520.

With respect to the meaning of the request, when a first non-AP STA 520 sends a first message or frame to the first AP device 510 requesting to start a TXSPG session 530 with an AP, the request may be interpreted as the first non-AP STA 520 requesting TXOP from the first AP device 510 for a P2P group or cluster in which the first non-AP STA 520 may be a member or that the first non-AP STA 520 manages. The received TXOP would be used for P2P data transmission within the P2P group.

Regarding the content of the request, when a first non-AP STA 520 sends a first message or frame to the first AP device 510 requesting to start a TXSPG session 530 with an AP, the request frame 522 may include information that identifies the P2P group for which the first non-AP STA 520 is requesting the TXOP or for which the first non-AP STA 520 intends to start the TXSPG session 530. For this purpose, the first non-AP STA 520 may include a P2P group ID (such as an ID to identify a P2P group) in the request frame 522.

Concerning the response to such a request, when a first non-AP STA 520 sends a first message or frame to the first AP device 510 requesting to start a TXSPG session 530 with an AP, and the request frame 522 includes information (for example, a P2P group ID) that identifies the P2P group for which the first non-AP STA 520 is requesting the TXOP or for which the first non-AP STA 520 intends to start the TXSPG session 530, upon receiving the request frame 522, when the first AP device 510 sends a response frame 512 to the first non-AP STA 520, the first AP device 510 may include the same P2P group ID in the response frame 512. When a first non-AP STA 520 sends a first message or frame to the first AP device 510 requesting to start a TXSPG session 530 with an AP, and the request frame 522 includes information (such as a P2P group ID) that identifies the P2P group for which the first non-AP STA 520 is requesting the TXOP or for which the first non-AP STA 520 intends to start the TXSPG session 530, upon receiving the request frame 522, if the P2P group ID sent by the first non-AP STA 520 has some conflict with any existing P2P group ID managed by the first AP device 510, when the first AP device 510 sends a response frame 512 to the first non-AP STA 520, the first AP device 510 may include a different P2P group ID in the response frame 512. This new P2P group ID suggested by the first AP device 510 will be used for the TXSPG session 530.

When a first non-AP STA 520 sends a first message or frame to the first AP device 510 requesting to start a TXSPG session 530 with an AP, the request frame 522 may include information that describes the traffic pattern of the P2P group corresponding to which the first non-AP STA 520 is requesting the TXOP or for which the first non-AP STA 520 intends to start the TXSPG session 530. For this purpose, the first non-AP STA 520 may send a QoS Characteristics element to the AP, where the QoS Characteristics element describes the traffic pattern of the P2P group. The QoS Characteristics element sent by the first non-AP STA 520 to the AP may be included in an SCS Request frame 522. Alternatively, the QoS Characteristics element sent by the first non-AP STA 520 to the AP may be included in any other management frame.

When a first non-AP STA 520 sends a first message or frame to the first AP device 510 requesting to start a TXSPG session 530 with the first AP device 510, and the request frame 522 includes information (for example, a QoS Characteristics element) that describes the traffic pattern of the P2P group corresponding to which the first non-AP STA 520 is requesting the TXOP or for which the first non-AP STA 520 intends to start the TXSPG session 530, upon receiving the request frame 522, the first AP device 510 may send a response frame 512 that also includes a QoS Characteristics element. With reference to this embodiment, if the first AP device 510 accepts the request, then the first AP device 510 may send the same QoS Characteristics element received from the first non-AP STA 520. If the first AP device 510 rejects the request or suggests an alternative set of parameters, then the first AP device 510 may send a different QoS Characteristics element than the one received from the first non-AP STA 520. Alternatively, if the first AP device 510 accepts the request, the first AP device 510 may choose not to send a QoS Characteristics element to the first non-AP STA 520. If the first AP device 510 sends a QoS Characteristics element to the first non-AP STA 520, the QoS Characteristics element may be included in an SCS Response frame or any other management frame.

Although FIG. 5 illustrates an example transmission diagram 500 of a TXSPG session negotiation procedure, various changes may be made to FIG. 5. For example, various components in FIG. 5 may be combined, further subdivided, replicated, omitted, or rearranged and additional components may be added according to particular needs.

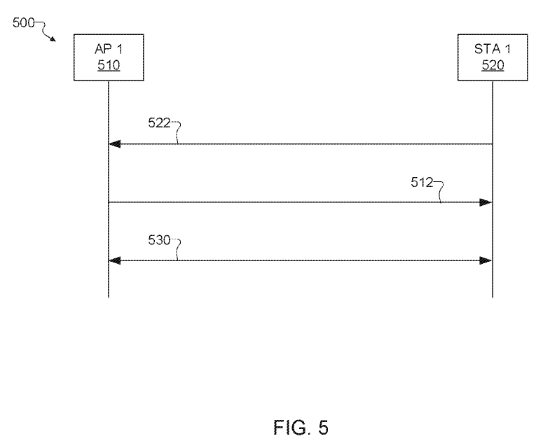

FIG. 6 illustrates an example flow chart of a method 600 for a TXSPG session negotiation procedure according to this disclosure. For ease of explanation, the method 600 of FIG. 6 is described as being performed using the system 300 of FIGS. 3A-3C. In particular, the method 600 may be performed by the first AP device 510 of FIG. 5. However, the method 600 may be used with any other suitable system and any other suitable system supporting a TXSPG session negotiation procedure.

As shown in FIG. 6, a transmission opportunity (TXOP) sharing with peer-to-peer group (TXSPG) support field of a capabilities element is set at step 602. For example, the AP device 410, the non-AP STA 420, or both may set a TXSPG support field to indicate capability to support TXSPG sessions as shown using the 400.

A request frame is received from a first non-AP STA of the group of P2P non-AP STAs, the request frame including a quality of service (QoS) characteristics element at step 604. For example, the first AP device 510 may receive a request frame 522 from the first non-AP STA 520. The request frame 522 may include a QoS characteristics element. The QoS characteristics element is configured to describe a traffic pattern corresponding to the traffic of the group of P2P non-AP STAs. The request frame includes an indication that the request is for sharing TXOP to the P2P group in which the first non-AP STA is a member.

The method 600 includes determining whether to accept a request from the first non-AP STA for a TXSPG session at step 606. For example, the first AP device 510 determines whether to accept the request for a TXSPG session indicated in the request frame 522. The first AP device 510 may determine to accept, reject, or provide another response to the request frame 522 based on the set a TXSPG support field of the first AP device 510, the first non-AP STA 520, or both.

A response frame is transmitted to the first non-AP STA indicating acceptance, rejection, or other response to the request frame at step 608. For example, the first AP device 510 may transmit a response frame 512 indicating a determined response to the request frame 522. Additionally or alternatively, the first non-AP STA 520 may receive the response frame 512. The response frame 512 may include an acceptance, rejection, or other response to the request frame 522. The response frame includes an identifier for the group of P2P non-AP STAs for the purpose of TXSPG operation. If the AP device indicates acceptance in the response frame, a TXSPG session starts between the AP device and the group of P2P non-AP STAs. Starting the TXSPG session may include using a TXOP received from the first AP device for P2P data transmission within the group of P2P non-AP STAs.

Although FIG. 6 illustrates an example flow chart of a method 600 for a TXSPG session negotiation procedure, various changes may be made to FIG. 6. For example, while shown as a series of steps, various steps in FIG. 6 may overlap, occur in parallel, or occur any number of times.

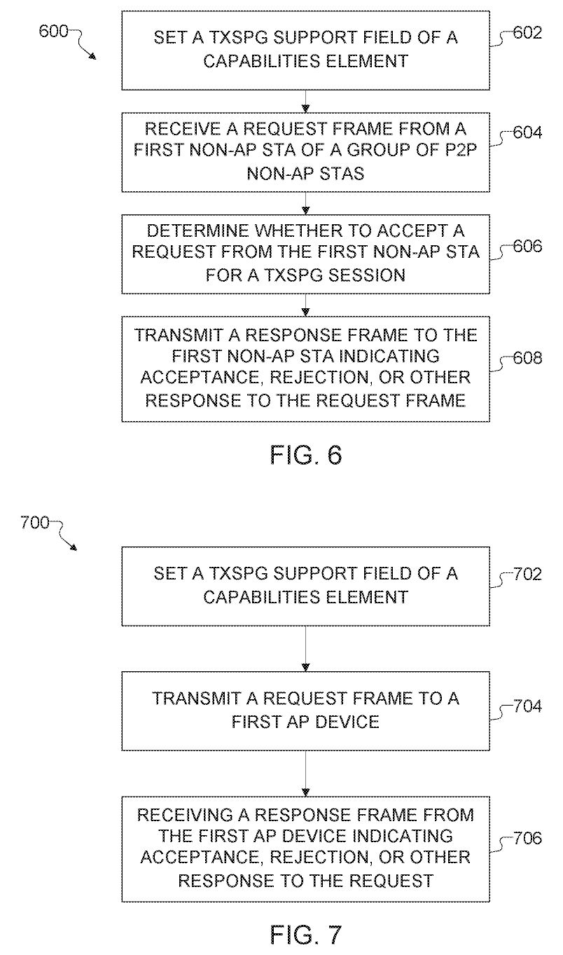

FIG. 7 illustrates an example flow chart of a method 700 for a TXSPG session negotiation procedure according to this disclosure. For ease of explanation, the method 700 of FIG. 7 is described as being performed using the system 300 of FIGS. 3A-3C. In particular, the method 600 may be performed by the first non-AP STA 520 of FIG. 5. However, the method 700 may be used with any other suitable system and any other suitable system supporting a TXSPG session negotiation procedure.

As shown in FIG. 7, a transmission opportunity (TXOP) sharing with peer-to-peer group (TXSPG) support field of a capabilities element is set at step 702. For example, the AP device 410, the non-AP STA 420, or both may set a TXSPG support field to indicate capability to support TXSPG sessions as shown using the 400.

A request frame is transmitted to a first AP device, where the request frame includes a quality of service (QoS) characteristics element at step 704. For example, the first non-AP STA 520 may transmit a request frame 522 to the first AP device 510. The request frame 522 may include a QoS characteristics element. The QoS characteristics element is configured to describe a traffic pattern corresponding to the traffic of the group of P2P non-AP STAs. The request frame includes an indication that the request is for sharing TXOP to the P2P group in which the first non-AP STA is a member.

A response frame is received from the first AP device indicating acceptance, rejection, or other response to the request at step 706. For example, the first non-AP STA 520 may receive the response frame 512 indicating a determined response to the request frame 522. The response frame 512 may include an acceptance, rejection, or other response to the request frame 522. The response frame includes an identifier for the group of P2P non-AP STAs for the purpose of TXSPG operation. If the AP device indicates acceptance in the response frame, a TXSPG session starts between the AP device and the group of P2P non-AP STAs. Starting the TXSPG session may include using a TXOP received from the first AP device for P2P data transmission within the group of P2P non-AP STAs.

Although FIG. 7 illustrates an example flow chart of a method 700 for a TXSPG session negotiation procedure, various changes may be made to FIG. 7. For example, while shown as a series of steps, various steps in FIG. 7 may overlap, occur in parallel, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by an access point (AP) device, the method comprising:
setting a transmission opportunity (TXOP) sharing with peer-to-peer group (TXSPG) support field of a capabilities element;
receiving a request frame from a first non-AP STA of the group of P2P non-AP STAs, the request frame including a quality of service (QoS) characteristics element;
determining whether to accept a request from the first non-AP STA for a TXSPG session; and
transmitting a response frame to the first non-AP STA indicating acceptance, rejection, or other response to the request frame.

2. The method of claim 1, wherein the request frame includes an indication that the request is for sharing TXOP to the P2P group in which the first non-AP STA is a member.

3. The method of claim 2, wherein the response frame includes an identifier for the group of P2P non-AP STAs for the purpose of TXSPG operation.

4. The method of claim 2, wherein the first non-AP STA manages the group of P2P non-AP STAs.

5. The method of claim 2, wherein if the AP device indicates acceptance in the response frame, a TXSPG session starts between the AP device and the group of P2P non-AP STAs.

6. The method of claim 1, wherein a TXOP received from the first AP device is used for P2P data transmission within the group of P2P non-AP STAs.

7. The method of claim 1, wherein the QoS characteristics element is configured to describe a traffic pattern corresponding to the traffic of the group of P2P non-AP STAs.

8. A method performed by a first non-access point (AP) station (STA) of a group of peer-to-peer (P2P) non-AP STAs, the method comprising:
setting a transmission opportunity (TXOP) sharing with peer-to-peer group (TXSPG) support field of a capabilities element;
transmitting a request frame to a first AP device, the request frame including a quality of service (QoS) characteristics element; and
receiving a response frame from the first AP device indicating acceptance, rejection, or other response to the request.

9. The method of claim 8, wherein the request frame includes an indication that the request is for sharing TXOP to the P2P group in which the first non-AP STA is a member.

10. The method of claim 9, wherein the response frame includes an identifier for the group of P2P non-AP STAs for the purpose of TXSPG operation.

11. The method of claim 9, wherein the first non-AP STA manages the group of P2P non-AP STAs.

12. The method of claim 9, wherein if the first AP device indicates acceptance in the response frame, a TXSPG session starts between the first AP device and the group of P2P non-AP STAs.

13. The method of claim 8, wherein a TXOP received from the first AP device is used for P2P data transmission within the group of P2P non-AP STAs.

14. The method of claim 8, wherein the QoS characteristics element is configured to describe a traffic pattern corresponding to the traffic of the group of P2P non-AP STAs.

15. An electronic device comprising:
at least one processor including processing circuitry; and
a memory storing instructions, wherein the instructions, when executed by the at least one processor individually or collectively, cause the electronic device to:
set a transmission opportunity (TXOP) sharing with peer-to-peer group (TXSPG) support field of a capabilities element;
receive a request frame from a first non-AP STA of the group of P2P non-AP STAs, the request frame including a quality of service (QoS) characteristics element;
determine whether to accept a request from the first non-AP STA for a TXSPG session; and
transmit a response frame to the first non-AP STA indicating acceptance, rejection, or other response to the request frame.

16. The electronic device of claim 15, wherein the request frame includes an indication that the request is for sharing TXOP to the P2P group in which the first non-AP STA is a member.

17. The electronic device of claim 16, wherein the response frame includes an identifier for the group of P2P non-AP STAs for the purpose of TXSPG operation.

18. The electronic device of claim 16, wherein the first non-AP STA manages the group of P2P non-AP STAs.

19. The electronic device of claim 16, wherein if the AP device indicates acceptance in the response frame, a TXSPG session starts between the AP device and the group of P2P non-AP STAs.

20. The electronic device of claim 15, wherein a TXOP received from the first AP device is used for P2P data transmission within the group of P2P non-AP STAs.
